(19) United States
(12) Patent Application Publication
(10) Pub. No.: US 2004/0198264 A1
(43) Pub. Date: Oct. 7, 2004

(54) Telephone radiation shielding devices

(76) Inventors: Ben Saur, Marlborough, MA (US); Diana M. Maichin, Marlborough, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/225,631

(22) Filed: Aug. 22, 2002

(51) Int. Cl. H04B 1/04

(52) U.S. Cl. 455/117; 455/550.1; 455/90.1; 455/575.1

(57) ABSTRACT

In one aspect the invention relates to a telephone radiation shielding apparatus. The radiation shielding apparatus includes a flexible conductive sheet, and a means for securing the flexible conductive sheet. The sheet is typically positioned within the telephone to receive incident non-ionizing radiation. In one embodiment, the radiation shielding apparatus further includes a conductive strip. The conductive strip is typically positioned to receive incident non-ionizing radiation. In one embodiment, wherein the means for securing the flexible conductive sheet comprises an adhesive. In another embodiment, the conductive sheet comprises a metallic material. In yet another embodiment, the conductive sheet comprises an aluminum mesh. In one embodiment, the aluminum mesh has a thickness of about 0.125 mm in gauge. In various embodiments, the telephone is a cellular telephone. In various other embodiments, the telephone is a cordless telephone.

### FIELD OF THE INVENTION

The present invention relates generally to the field of radiation shielding and, more specifically, to shielding the radiation emitted by cellular and cordless telephones.

### BACKGROUND OF THE INVENTION

Radiofrequency radiation is produced by mobile (cellular) phones and cordless telephones. This type of radiation is also referred to as non-ionizing radiation because it does not cause atoms or molecules to gain or lose electrons. Non-ionizing radiation does not cause the break down of chemical bonds, but it can result in induced high currents and thermal heating. Although the consequences of cellular telephone and cordless phone non-ionizing radiation are not fully understood, it is possible that introduction of this type of radiation into animal tissue might have deleterious effects.

Research is currently being conducted to study the long-term effects of the non-ionizing radiation produced by various devices. While the effects of non-ionizing radiation are being determined, engineering efforts continue to produce communication devices which exhibit a reduction in output radiation. The impetus for these efforts results, in part, from the recent growth in cellular telephone usage. Because cellular phones have only grown in popularity in the last ten years, officials are uncertain as to whether the phones can induce harmful effects in humans.

Studies have shown that harmful consequences can occur to some organisms as a result of prolonged non-ionizing radiation exposure. For example, exposure to non-ionizing radiation for periods of less than 30 minutes can produce cataracts in rabbits' eyes. Further, according to some researchers people are two-and-one-half times more likely to develop a malignant tumor or a cancer on the side of their head on which they use their phone than they are on the other. Although it is not proven that these communication devices can indeed cause cancer, it is known that prolonged exposure to different types of radiation can have harmful effects, such as biological defects and genetic mutations. Therefore in the absence of data showing a clear repeatable correlation between cellular telephone radiation and negative effects on living tissue, designing devices to limit our intake of non-ionizing radiation may be prudent.

There are some highly publicized radiation-shielding products on the market today. Unfortunately, several do not live up to their claims; and may actually increase the amount of radiation entering the user's brain. These products also tend to decrease the quality of signal the cellular phone receives.

Various devices based on the radiation absorption properties have been developed to date. The majority of these devices are applied to the outside of a telephone to reduce the amount of emitted radiation. What is needed is a cost-effective device, which is easy to assemble, compact, lightweight, and that does not interfere with the functionality of a phone while still reducing the levels of non-ionizing radiation received by the user.

### SUMMARY OF THE INVENTION

The present invention relates to a method and approach to facilitate a reduction in the emission of non-ionizing radiation from a telephone. In various aspects, the invention relates to a device which prevents the radiation emitting by a cellular telephone or cordless telephone from entering the human brain.

In one aspect the invention relates to a telephone radiation shielding apparatus. The radiation shielding apparatus includes a flexible conductive sheet, and a means for securing the flexible conductive sheet. The sheet is typically positioned within the telephone to receive incident non-ionizing radiation. In one embodiment, the radiation shielding apparatus further includes a conductive strip. The conductive strip is typically positioned to receive incident non-ionizing radiation. In one embodiment, the means for securing the flexible conductive sheet includes an adhesive. In another embodiment, the conductive sheet includes a metallic material. In yet another embodiment, the conductive sheet includes an aluminum mesh. In one embodiment, the aluminum mesh has a thickness of about 0.125 mm in gauge. In various embodiments, the telephone is a cellular telephone. In various other embodiments, the telephone is a cordless telephone.

In another aspect the invention relates to a telephone including a non-ionizing radiation emitting element having a specific geometry, a telephone housing, and a conductive sheet disposed upon a portion of the radiation emitting element. Typically, the telephone housing contains the radiation emitting element. The conductive sheet substantially conforms to a portion of the specific geometry of the non-ionizing radiation emitting element. In one embodiment, the conductive sheet includes a metallic material. In one embodiment, the conductive sheet includes an aluminum mesh. The aluminum mesh has a thickness of about 0.125 mm in gauge in one embodiment.

In another embodiment, the telephone includes an adhesive for securing the conductive sheet to a portion of the specific geometry of the non-ionizing radiation emitting element. In another embodiment, the telephone includes a conductive strip positioned to receive incident non-ionizing radiation within the telephone, wherein the conductive strip is located within the cellular telephone housing.

In one aspect the invention relates to a cellular telephone modification kit. The modification kit includes a conductive sheet sized and configured for insertion within a cellular telephone, and a tool. The sheet is positioned to receive incident non-ionizing radiation within the cellular telephone. The tool is suitable for opening the cellular telephone in order to install the conductive sheet. In one embodiment, the modification kit further includes an adhesive, such that the adhesive is suitable for securing the conductive sheet within the telephone. In one embodiment, the conductive sheet comprises a metallic material. In one embodiment, the conductive sheet includes an aluminum mesh. In one embodiment, the aluminum mesh has a thickness of about 0.125 mm in gauge.

### BRIEF DESCRIPTION OF THE DRAWINGS

The invention is pointed out with particularity in the appended claims. The advantages of the invention described above, together with further advantages, may be better understood by referring to the following description taken in conjunction with the accompanying drawings. In the drawings, like reference characters generally refer to the same parts throughout the different views. The drawings are not necessarily to scale, emphasis instead generally being placed upon illustrating the principles of the invention.

FIGS. 1A and 1B are perspective interior views of two portions of a telephone housing incorporating an illustrative embodiment of the invention;

FIGS. 1C and 1D are perspective interior views of two portions of another style of telephone housing incorporating an illustrative embodiment of the invention;

FIGS. 2A and 2B are schematic diagrams illustrating a side view of a cellular telephone in a non-energized state and an energized state respectively;

FIG. 3 is a schematic diagram of a radiation shielding device known in the prior art; and

FIG. 4 is a schematic diagram of a radiation shielding device according to an illustrative embodiment of the invention.

### DESCRIPTION OF THE PREFERRED EMBODIMENTS

Embodiments of the present invention are described below. It is, however, expressly noted that the present invention is not limited to these embodiments, but rather the intention is that modifications that are apparent to the person skilled in the art and equivalents thereof are also included.

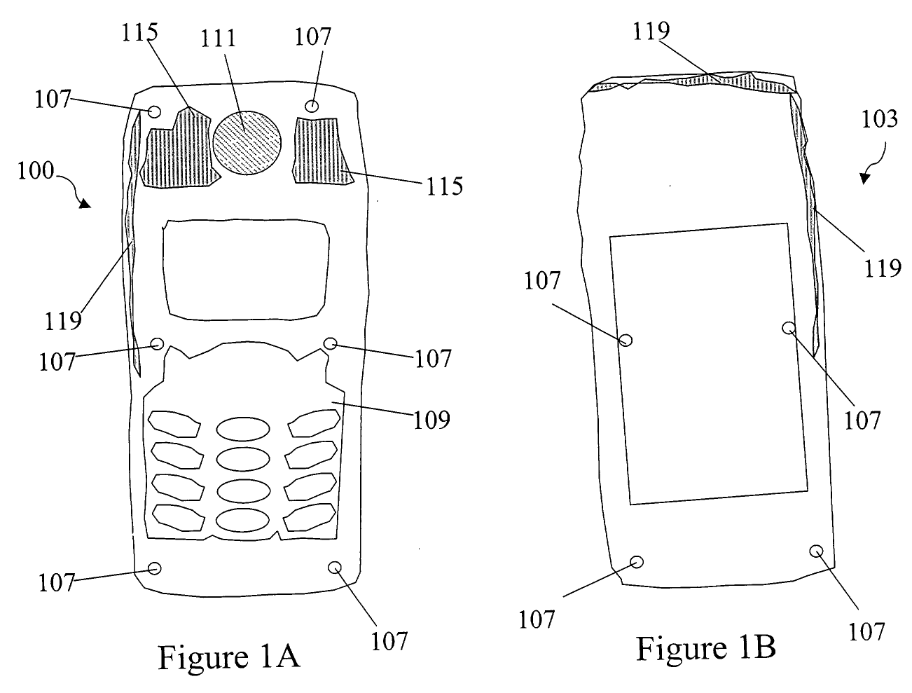

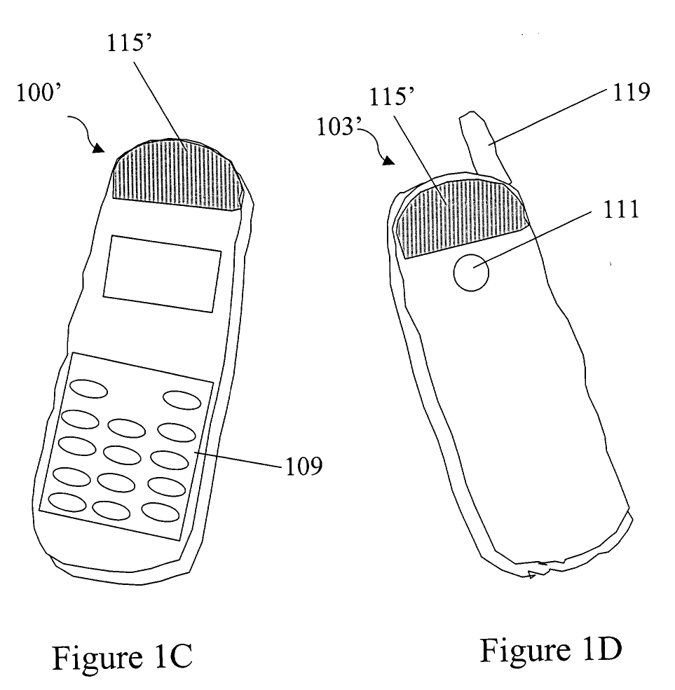

Referring to FIGS. 1A and 1B, a cellular housing including a top housing portion 100 and a bottom housing portion 103 is shown. Typically, the top housing portion 100 and the bottom housing portion 103 are joined at certain connection points 107 by various suitable fixation means (not shown) such as screws or adhesive. The back part of the phone keypad 109 and a speaker 111 are also shown. The internal electronic components of the phone which typically reside within both housing portions are not shown. The various aspects of the invention are applicable to both cellular and cordless telephones.

When the electronic components within the phone are energized non-ionizing radiation is produced by the various radiation emitting elements. These radiation emitting elements include but are not limited to antenna components, wiring, induction coils, transistors, integrated circuit chips, and any other type of non-ionizing radiation inducing elements found within a cellular, cordless phone or equivalent.

The invention provides for incorporating conductive sheets within the cellular telephone housing. In various embodiments, conductive strips of material can also be used. In some embodiments a metallic mesh is used for the conductive sheet and a metal foil is used to form the conductive strips. Referring to FIGS. 1A and 1B, two conductive sheets 115 are shown disposed in the housing top portion 115 to the right and left of the speaker 111. A conductive strip 119 is also shown in this illustrative embodiment. Although the conductive sheet 115 and the conductive strip 119 are shown as two-dimensional regions in FIGS. 1A and 1B, they are flexible three-dimensional objects that can be shaped to conform to the geometry of various radiation emitting elements located within an operational telephone. The conductive sheet 115 and the conductive strip are attached to the telephone housing portions 100, 103 by frictional means or various adhesive means such as, but not limited to, liquid glue. In one embodiment, conductive strips in the form of thin pieces of aluminum sheet metal can be secured within the phone to the upper sides and top of the phone, as well as the ear contact region of the phone. In other embodiments the conductive sheet 115 and conductive strip 109 can be directly incorporated within the housing portions 100, 103 during the fabrication of the telephone and its component parts. In various embodiments, metallic materials are used to fabricate the conductive sheet and conductive strip. Suitable metallic materials include but are not limited to copper, zinc, lead, gold, silver, and platinum, and chromium. In some embodiments the conductive sheet can include silicon and various conductive dopants.

FIGS. 1C and 1D, illustrate an embodiment of the invention disposed within a different style of telephone housing. The housing portions 100′, 103′ have conductive sheets 115′ disposed at the top ear region of the telephone. These conductive sheets 115′ line the interior of the telephone and form a closed cavity when the telephone is closed and in use. The telephone antenna 119 has regions within the telephone that emit non-ionizing radiation. In various embodiments, these radiation emitting elements are typically covered by a conductive sheet or a bounded by a conductive. Generally, the conductive sheet and/or conductive strip can be positioned anywhere within a telephone to receive incident non-ionizing in various embodiments as taught by the invention.

Without being held to a particular theory or mechanism, the introduction of the conductive sheets and conductive strips operate as a Faraday Cage which prevents the non-ionizing radiation from entering the biological tissues in the head of the telephone user. It has been found that the invention increases signal strength while shielding the user from radiation. In one preferred embodiment using aluminum mesh as the conductive sheet the invention blocked approximately 99% of the radiation emitted by various test phones. These test phones included the Nokia 3360, Nokia 7160, Nokia 8260, and the Motorola Timeport MT3, (Nokia:United States Headquarters Irving, Tex., Motorola: United States Headquarters Schaumburg, Ill.).

The various aspects of the invention are fairly simple to manufacture and install, yet operate as an effective means to reduce non-ionizing radiation in cordless and cellular telephones. A special tool is required to dismantle each phone prior to the insertion of the conductive sheets and conductive strips. Another aspect of the invention provides phone modification kits for reducing the radiation emitted by an existing phone by incorporating the radiation shielding devices disclosed herein. A tool suitable for opening an existing telephone and a conductive strip to insert within the housing in a position to receive incident non-ionizing radiation are typically present in such a kit. Other embodiments of these phone modification kits also include conductive strips. Still other embodiments of these kits include adhesive for securing the conductive sheets or strips in place within the telephone. However, when the radiation shielding devices are manufactured as part of the phone itself these additional steps and kits would not be required.

Various embodiments of the invention prevent 99-100% of the non-ionizing radiation emitted by cellular phones from entering the ear and the brain. Various aspects of the invention also increase the phone's signal strength by 10-30%, depending on where the conductive sheets and strips are positioned within the phone. Typically the invention is implemented so as not to be visible to the user. It is light, cost effective, safe, and an improvement with respect to the other radiation-shielding products. This product could also be implemented in other wireless devices, such as portable telephones, PDA's or other wireless devices.

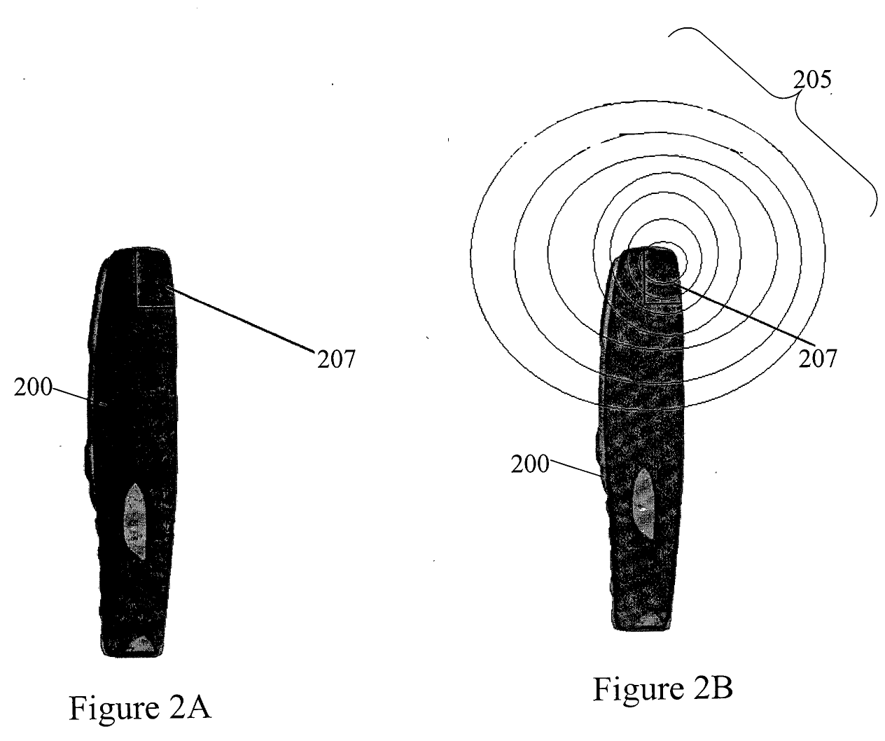

Referring to FIGS. 2A and 2B, a telephone 200 is illustrates in both an “Off” and “On” configuration respectively. The telephone shown in FIG. 2A is not energized, therefore no radiation is being emitted. In FIG. 2B, the concentric field lines 205 are shown radiating outwards from the top portion of the energized telephone 200. Some of the field lines 205 are emanating form the antenna 207. The present invention operates to reduce the telephone user's exposure to this radiation 205.

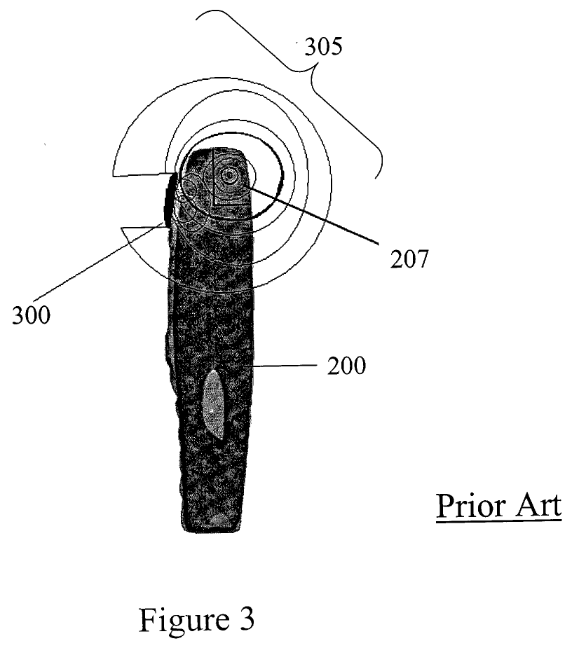

In FIG. 3, a prior art approach to telephone radiation shielding is shown. A Waveshield (Interact Communications, Inc., Florida) device 300 is positioned on the exterior of the phone 200. This device 300 selectively blocks non-ionizing radiation 305 in the region where it is positioned on the phone exterior. Since the device 300 is placed on the outside of the phone it fails to block all of the non-ionizing radiation 305 incident on the user. The present invention is designed to provide greater radiation shielding protection.

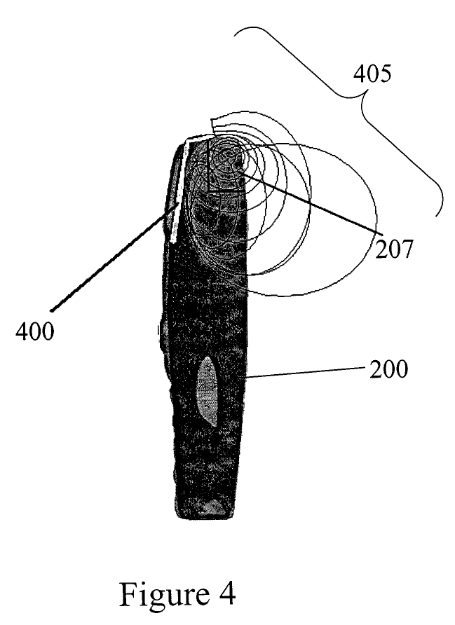

Referring to FIG. 4, an illustrative embodiment of the radiation shielding device 400 of the invention is shown within an energized telephone 200. The non-ionizing radiation 405 being emitted from the telephone 200 is blocked by the conductive sheets and conductive strips present within the radiation shielding device 400. Since the radiation shielding elements are present within the phone, a greater volume of non-ionizing radiation 405 is blocked. In addition, given the ease of installation and manufacture the present invention represents an improvement over the prior art.

What is claimed is:

1. A telephone radiation shielding apparatus comprising:
a flexible conductive sheet, wherein the sheet is positioned within the telephone to receive incident non-ionizing radiation; and
means for securing the flexible conductive sheet within the telephone.

2. The radiation shielding apparatus of claim 1 further comprising a conductive strip, wherein the conductive strip is positioned to receive incident non-ionizing radiation.

3. The radiation shielding apparatus of claim 1 wherein the means for securing the flexible conductive sheet comprises an adhesive.

4. The radiation shielding apparatus of claim 1 wherein the conductive sheet comprises a metallic material.

5. The radiation shielding apparatus of claim 1 wherein the conductive sheet comprises an aluminum mesh.

6. The radiation shielding apparatus of claim 5 wherein the aluminum mesh has a thickness of about 0.125 mm in gauge.

7. The radiation shielding apparatus of claim 1 wherein the telephone is a cellular telephone.

8. The radiation shielding apparatus of claim 1 wherein the telephone is a cordless telephone.

9. A telephone comprising:
a non-ionizing radiation emitting element having a specific geometry;
a telephone housing, wherein the telephone housing contains a radiation emitting element; and
a conductive sheet disposed upon a portion of the radiation emitting element, wherein the conductive sheet substantially conforms to a portion of the specific geometry of the non-ionizing radiation emitting element.

10. The telephone of claim 9 wherein the conductive sheet comprises a metallic material.

11. The telephone of claim 9 wherein the conductive sheet comprises an aluminum mesh.

12. The telephone of claim 11 wherein the aluminum mesh has a thickness of about 0.125 mm in gauge.

13. The telephone of claim 9 further comprising an adhesive for securing the conductive sheet to a portion of the specific geometry of the non-ionizing radiation emitting element.

14. The telephone of claim 9 further comprising a conductive strip positioned to receive incident non-ionizing radiation within the telephone, wherein the conductive strip is located within the cellular telephone housing.

15. The telephone of claim 9 wherein the telephone is a cellular telephone.

16. The telephone of claim 9 wherein the telephone is a cordless telephone.

17. A cellular telephone modification kit comprising:
a conductive sheet sized and configured for insertion within the cellular telephone, wherein the sheet is positioned to receive incident non-ionizing radiation within the cellular telephone; and
a tool, wherein the tool is suitable for opening the cellular telephone in order to install the conductive sheet.

18. The cellular telephone modification kit of claim 17 further comprising an adhesive, wherein the adhesive is suitable for securing the conductive sheet within the telephone.

19. The cellular telephone modification kit of claim 17 wherein the conductive sheet comprises a metallic material.

20. The cellular telephone modification kit of claim 17 wherein the conductive sheet comprises an aluminum mesh.

21. The cellular telephone modification kit of claim 20 wherein the aluminum mesh has a thickness of about 0.125 mm in gauge.
